(19) United States
(12) Patent Application Publication
(10) Pub. No.: US 2023/0411740 A1
(43) Pub. Date: Dec. 21, 2023

(54) BATTERY CASE AND BATTERY

(71) Applicant: EVE POWER CO., LTD., JINGMEN (CN)

(72) Inventors: XIAOWU HE, JINGMEN (CN); KUANJIN SHU, JINGMEN (CN); ZHEN DENG, JINGMEN (CN); XU ZHENG, JINGMEN (CN); YUMU TAN, JINGMEN (CN); WEI HE, JINGMEN (CN)

(21) Appl. No.: 18/459,408

(22) Filed: Aug. 31, 2023

Related U.S. Application Data
(63) Continuation of application No. PCT/CN2022/143963, filed on Dec. 30, 2022.

(30) Foreign Application Priority Data
Jun. 21, 2022 (CN) 202221564467.5

(51) Int. Cl. H01M 50/103; H01M 50/30

(52) U.S. Cl. CPC H01M 50/103; H01M 50/394

(57) ABSTRACT

A battery case and a battery are provided. The battery case includes a case body. The case body is formed by a sheet-shaped plate being bent and welded. The plate has a first end and a second end. After the case body is bent, the first end is welded to the second end, a welding position at which the first end is welded to the second end is compressed to form an explosion-proof recess.

### CROSS REFERENCE TO RELATED APPLICATIONS

The present application is a continuation-application of the international patent application No. PCT/CN2022/143963, filed on Dec. 30, 2022, which claims the priority of Chinese patent application No. 202221564467.5, filed on Jun. 21, 2022, to the China National Intellectual Property Administration, and contents of which are incorporated herein by its entireties.

### TECHNICAL FIELD

The present disclosure relates to the field of batteries, and in particular to a battery case and a battery including the battery case.

### BACKGROUND

As known in the art, lithium-ion batteries have a certain probability of having internal short-circuits or external short-circuits while in use. The short-circuits may result in a temperature inside a battery case being increased and generating a large amount of gas, such that the battery may expand and explode, the battery may not be used safely. Therefore, a pressure relief structure needs to be arranged on the battery. When the battery is expanding, the generated gas inside the battery case may be discharged through the pressure relief structure, preventing the battery from exploding. The battery includes a battery case, a cell, and a cover plate. At least one end of the battery case has an opening. The cell is received inside the battery case. The cover plate blocks the opening of the battery case. In the art, the pressure relief structure is generally arranged on a top cap. For example, the top cap defines an explosion-proof valve hole, which extends through the top cap. In addition, an explosion-proof sheet is arranged to block the explosion-proof valve hole. The explosion-proof valve hole and the explosion-proof sheet cooperatively serve as the pressure relief structure. However, the pressure relief structure in the art has following shortcomings. The top cap needs to be punched to define the explosion-proof valve hole, and the explosion-proof sheet is to be arranged in addition. Further, the explosion-proof sheet is made of special material. Therefore, a complicated manufacturing process may be performed, and a manufacturing cost is high.

### SUMMARY OF THE DISCLOSURE

The present disclosure provides a battery case, having a simple structure and a low manufacturing cost.

The present disclosure provides a battery, which may be manufactured easily and has a low manufacturing cost.

In a first aspect, a battery case is provided and includes a case body. The case body is formed by a sheet-shaped plate being bent and welded, the plate has a first end and a second end; after the case body is bent, the first end is welded to the second end, a welding position at which the first end is welded to the second end is compressed to form an explosion-proof recess.

In some embodiments, a weld seam is formed at the welding position of the first end and the second end, a length of the explosion-proof recess extends in a length direction of the weld seam.

In some embodiments, the length of the explosion-proof recess is equal to the length of the weld seam.

In some embodiments, a width of the explosion-proof recess is in a range of 0.3 mm to 2 mm.

In some embodiments, the explosion-proof recess extends to reach at least one of the first end and the second end.

In some embodiments, each of an outer side wall and an inner side wall of the case body defines the explosion-proof recess, the explosion-proof recess in the outer side wall is directly facing towards the explosion-proof recess in the inner side wall.

In some embodiments, a thickness d of a side wall of the case body is greater than a depth h of the explosion-proof recess, and 0.15≤d≤0.7 mm, 0.05≤h≤0.2 mm.

In some embodiments, the explosion-proof recess has a recess bottom and two recess side walls, the two recess side walls are opposite to each other, the recess bottom is disposed between the two recess side walls, an angle between the recess bottom and each of the two recess side walls is in a range of 100° to 160°.

In some embodiments, a length of the case body is in a range of 100 mm to 2500 mm.

In a second aspect, a battery is provided and incudes the battery case as described in the above.

In the present disclosure, after welding is performed at the joint between plates, a bump is generated at the welding position. In the present disclosure, the explosion-proof recess is defined at two ends of the case body that are connecting with each other and is defined by the two ends being compressed. The welding position of the case body is compressed and trimmed to form the explosion-proof recess. In this way, structural strength of the welding position of the case body is improved, the bump generated during the welding process is eliminated, and aesthetics of the case body is improved. In addition, the explosion-proof recess is extruded directly at the welding position of the case body, such that thickness of the welding position of the case body is reduced. Therefore, when a large amount of gas is generated, due to the short-circuit of the battery, inside the case body, the high-pressure gas may break through the explosion-proof recess, and the pressure is released. Therefore, the explosion-proof hole and the explosion-proof sheet may not be arranged on the battery case. Structure of the battery case is simplified, and the manufacturing cost is reduced.

### BRIEF DESCRIPTION OF THE DRAWINGS

FIG. 1 is a perspective schematic view of a battery case according to some embodiments of the present disclosure.

FIG. 2 is a side view of a battery case, being viewed from a first viewing angle, according to some embodiments of the present disclosure.

FIG. 3 is a top view of a battery case according to some embodiments of the present disclosure.

FIG. 4 is an enlarged view of a portion I in FIG. 3.

FIG. 5 is a side view of a battery case being viewed from a second viewing angle when a first end and a second end of the battery case are not welded with each other, according to some embodiments of the present disclosure.

FIG. 6 is an enlarged view of a portion II in FIG. 5.

FIG. 7 is a top view of the battery case being viewed from the second viewing angle when the first end and the second end of the battery case are welded with each other, according to some embodiments of the present disclosure.

FIG. 8 is an enlarged view of a portion III in FIG. 7.

### REFERENCE NUMERALS IN THE DRAWINGS

1, case body; 11, first end; 12, second end; 2, explosion-proof recess; 21, recess side wall; 22, recess bottom; 3, gap.

### DETAILED DESCRIPTION

In the specification of the present disclosure, unless otherwise expressly specified and limited, terms “connected”, “coupled”, “fixed” shall be understood broadly. For example, the terms may indicate fixed connection, detachable connection, or components being configured as a one-piece and integral structure; may indicate mechanical connection or electrical connection; direct connection or indirect connection through an intermediate medium; internal communication between two elements or interaction between two elements. Any ordinary skilled person in the art shall the meaning of the above terms in the present disclosure based on actual situations.

In the specification of the present disclosure, unless otherwise expressly specified and limited, a first feature being “above” or “below” a second feature may include the first feature directly contacting the second feature or the first feature indirectly contacting the second feature through another feature therebetween. Furthermore, the first feature being “above”, “on top of” and “on” the second feature includes the first feature being directly above and diagonally above the second feature or simply indicates that the first feature is horizontally higher than the second feature. The first feature being “below”, “under” and “beneath” the second feature includes the first feature being directly below and diagonally below the second feature or simply indicates that the first feature is horizontally lower than the second feature.

In the present specification, the terms “up”, “down”, “left”, “right”, and other orientations or positional relationships are based on orientations or positional relationships shown in the accompanying drawings. The orientations or positional relationships are used only to facilitate description and to simplify operations, and are not intended to indicate or imply that devices or elements referred to must have a particular orientation, be constructed and operated in a particular orientation. Therefore, the terms shall not be interpreted as a limitation of the present disclosure. Furthermore, the terms “first” and “second” are used only for descriptive purposes and have no special meaning.

In the specification of the present specification, the terms “an embodiment”, “example”, and so on, are intended to indicate that features, structures, material, or characteristic described in conjunction with the embodiment or the example are included in at least one embodiment or example of the present disclosure. In the present specification, schematic expressions of the above terms do not necessarily refer to a same embodiment or a same example.

In addition, although the present specification is described in accordance with the embodiments, it shall not be understood as each embodiment including only one independent technical solution. The description manner of the specification is merely for clarity. Any ordinary skilled person in the art shall take the specification as a whole, and technical solutions in the plurality of embodiments may be appropriately combined to form other embodiments that may be understood by any ordinary skilled person in the art.

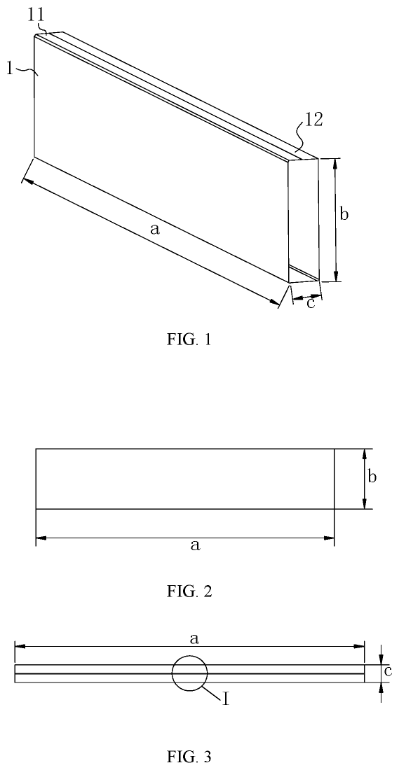

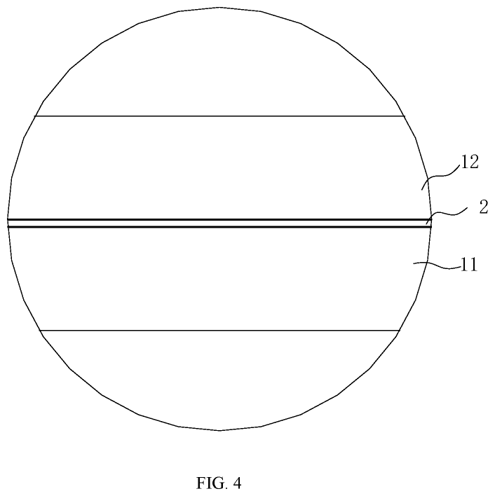

As shown in FIG. 1 to FIG. 8, the present disclosure provides a battery case including a case body 1. The case body 1 is formed by a sheet-shaped plate being bent and welded. The plate has a first end 11 and a second end 12. After bending of the case body 1, the first end 11 is welded to the second end 12. A position at which the first end 11 is welded to the second end 12 is compressed to define an explosion-proof recess 2.

After the welding is completed at the position where the two ends are aligned and connected with each other, a bump is generated at the welding position. In the present disclosure, the explosion-proof recess 2 is defined at the position where the two ends are aligned and connected with each other and is formed by compressing the two ends. The welding position of the case body 1 is compressed and trimmed to form the explosion-proof recess 2. In this way, structural strength of the welding position of the case body 1 is improved, the bump formed during the welding process is eliminated, and aesthetics of the case body 1 is improved. In addition, by performing compression to form the explosion-proof recess 2 at the welding position of the case body 1, the structural strength of the case body 1 at the position of the explosion-proof recess 2 is reduced. When a battery short-circuit generates a large amount of gas inside the case body 1, the high-pressure gas may break through the explosion-proof recess 2, and the high pressure may be released. An explosion-proof hole and an explosion-proof sheet may not be additionally arranged on the battery case. Structure of the battery case is simplified, and the manufacturing cost is reduced.

In the present embodiment, the sheet-shaped plate is rectangular. The plate has the first end 11 and the second end 12 opposite to the first end 11. The plate is bent, and the first end 11 and the second end 12 are connected with each other by welding. In other embodiments, the structure of the plate may not be rectangular, but may be triangular. When the plate is triangular, the first end 11 and the second end 12 are two adjacent ends of the triangular plate. Alternatively, the plate may be polygonal, and the first end 11 and the second end 12 may be or may not be adjacent ends of the polygonal plate.

For example, a weld seam is formed at the welding position of the first end 11 and the second end 12. A length of the explosion-proof recess 2 extends in a length direction of the weld seam. The explosion-proof recess 2 having a certain length allows the pressure to be released easily, ensuring safety of the battery.

For example, the length of the explosion-proof recess 2 is equal to the length of the weld seam. In this way, when the explosion-proof recess 2 is formed by compressing the position at which the first end 11 and the second end 12 are welded, various positions of the weld seam are also compressed and trimmed, preventing cracks from being formed due to a part of the weld seam being untrimmed, such that sealing performance of the battery case is ensured.

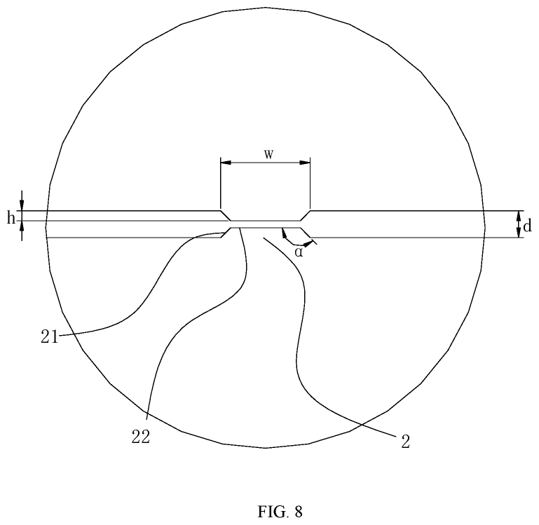

In the present embodiment, as shown in FIG. 8, a width w of the explosion-proof recess 2 is in a range of 0.3 mm to 2 mm. For an explosion-proof recess 2 having an excessively large width, when the short circuit occurs inside the battery case, pressures of the high-pressure gas inside the case body 1 may be excessively dispersed, and therefore, the high-pressure gas may not easily break through the explosion-proof recess 2, such that pressure release may not be achieved through the explosion-proof recess 2. For an explosion-proof recess 2 having an excessively small width, the compressing may not be performed easily, and the weld seam may not be trimmed easily, and therefore, the structural strength of the weld seam may not be ensured.

In the process of performing the compression to form the explosion-proof recess 2, in order to enable both the first end 11 and the second end 12 of the plate to be compressed to ensure the structural strength of the welding position between the first end 11 and the second end 12, the explosion-proof recess 2 extends to reach the first end 11 and the second end 12. Each of the first end 11 and the second end 12 serves as a portion of a wall or a bottom 22 of the explosion-proof recess 2.

In other embodiments, the explosion-proof recess 2 may extend to reach the first end 11 only or to reach the second end 12 only.

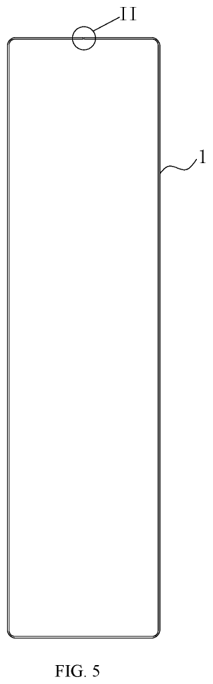

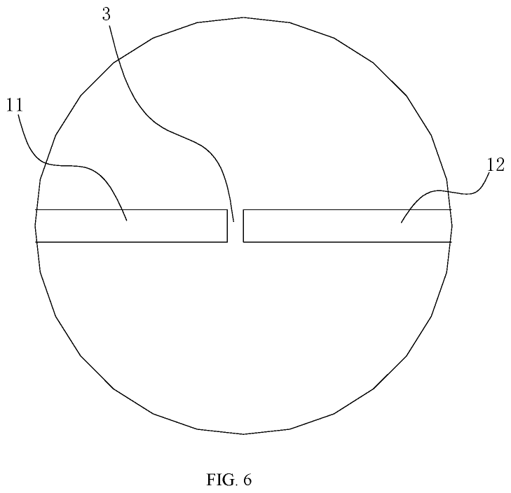

In the present embodiment, as shown in FIG. 5 and FIG. 6, a gap 3 between the first end 11 and the second end 12, before the first end 11 and the second end 12 are welded with each other, is in a range from 0.2 mm to 1 mm.

For the battery case in an embodiment, each of an outer side wall and an inner side wall of the case body 1 defines the explosion-proof recess 2. The explosion-proof recess 2 in the outer side wall is directly facing towards the explosion-proof recess 2 in the inner side wall. Since the explosion-proof recess 2 in the outer side wall is directly facing towards the explosion-proof recess 2 in the inner side wall, the outer side wall and the inner side wall of the case body 1 may be compressed at the same time to form the explosion-proof recess 2. That is, the explosion-proof recess 2 may not be formed by performing separated operations. Therefore, the number the operations for processing the battery case is reduced. In addition, in the process of performing the compression to form the explosion-proof recess 2, both the outer side wall and the inner side wall of the case body 1 are trimmed, bumps formed, due to welding, on the outer side wall and the inner side wall of the case body 1 are eliminated. Therefore, the case body 1 are arranged to be flat, and quality of the battery case is improved. In other embodiments, the explosion-proof recess 2 may be defined only in the outer side wall of the case body 1 or only in the inner side wall of the case body 1. In this way, structural styles of the battery case may be increased, and application scenarios of the battery case may be expanded.

For example, as shown in FIG. 8, a thickness d of the side wall of the case body 1 is greater than a depth h of the explosion-proof recess 2, and 0.15≤d≤0.7 mm, and 0.05≤h≤0.2 mm. When the thickness d of the side wall of the case body 1 is controlled within a certain range, the depth h of the explosion-proof recess 2 is controlled in a range from 0.05 mm to 0.2 mm. In this way, while the explosion-proof recess 2 enables the pressure release to be achieved, the side wall may have a certain pressure resistance capability.

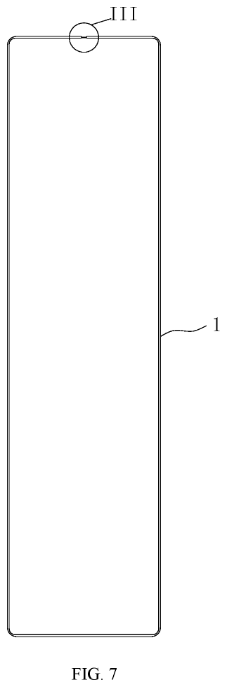

In the present embodiment, as shown in FIG. 1, FIG. 7, and FIG. 8, the plate is rectangular. The first end 11 and the second end 12 are opposite to each other. After bending and welding, the entire case body 1 is a rectangular structure having two openings at two ends respectively. The explosion-proof recess 2 includes a recess bottom 22 and two recess side walls 21. The two recess side walls 21 are opposite to each other. The recess bottom 22 is disposed between the two recess side walls 21. An angle α between the recess bottom 22 and each of the two recess side walls 21 is in a range of 100° to 160°. Since the angle α between the recess bottom 22 and each of the two recess side walls 21 is in the range of 100° to 160°, the thickness of the case body 1 at a position corresponding to the recess side walls 21 decreases gradually along a direction extending from an opening of the explosion-proof recess 2 towards the recess bottom 22, preventing the case body 1 from being fractured caused by the thickness being decreased drastically.

For example, as shown in FIG. 1 to FIG. 3, a length a of the case body 1 is in a range of 100 mm to 2500 mm, a height b of the case body 1 is in a range of 50 mm to 200 mm, and the thickness c of the case body 1 is in a range of 10 mm to 50 mm. This size of the case body 1 is suitable for most types of batteries. In practice, the size of the case body 1 may be flexibly determined according to demands.

The plate may be an aluminium plate, a plastic plate or a steel plate, and so on. The plate may be an aluminium alloy plate. The aluminium alloy has a low density, but a high strength. The strength of the aluminium alloy is close to or exceeds strength of a high quality steel. The aluminium alloy has better plasticity and is material that is commonly used for manufacturing the battery case.

In an embodiment, a process for manufacturing the battery case as described above is provided and includes following operations.

In an operation S100, the plate is provided. The plate has the first end 11 and the second end 12. The plate is bent to enable the first end 11 to be aligned with the second end 12. Welding is performed at the position where the first end 11 and the second end 12 are aligned with each other.

In an operation S200, forming the explosion-proof recess 2 by compressing the position where the first end 11 and the second end 12 are welded.

In the method of manufacturing the above battery case, since the welding position between the first end 11 and the second end 12 of the plate are compressed to form the explosion-proof recess 2, in the process of performing compression to form the explosion-proof recess 2, the welding position between the first end 11 and the second end 12 is compressed and trimmed. In this way, while the case body 1 allows the pressure release to be achieved, the bump formed on the case body 1 due to the welding is eliminated. That is, compressing to form the explosion-proof recess 2 and trimming the welding position on the case body 1 are performed at the same time by one operation. The number of operations for manufacturing the battery case is reduced, and the structure of the battery case is simplified, the efficiency of the processing the battery case is improved, and the manufacturing cost is reduced.

Exemplarily, the process for manufacturing the above battery case further includes an operation S300, annealing the case body 1. Exemplarily, a temperature of the annealing treatment is 280-350° C. A time length of the annealing treatment is 60-120 min. After the case body is compressed, hardness of the case body 1 is large, and the case body may be fractured easily. After compressing the case body 1, the annealing treatment in the present operation enables the case body 1 to release the stresses and enables case body 1 to restore ductility and toughness. In this way, the case body 1 is prevented from being fractured, and the service life of the case body 1 may be extended.

During processing, the welding position between the first end 11 and the second end 12 is compressed by a compression tool. The compression tool includes a first compression block and a second compression block. The first compression block may be placed at the outside the case body 1, and the second compression block may be placed at the inside the case body 1. Both the first compression block and the second compression block abut against the welding position of the first end 11 and the second end 12. The first compression block and the second compression block are tightly clamped against each other. In this way, the outer side wall and the inner side wall of the case body 1 are compressed at the same time to form the explosion-proof recess 2.

In an embodiment, a battery is provided and includes the battery case of any of the above described structures. The battery may be easily manufactured and has a low manufacturing cost.

What is claimed is:

1. A battery case, comprising a case body, wherein the case body is formed by a sheet-shaped plate being bent and welded, the plate has a first end and a second end; after the case body is bent, the first end is welded to the second end, a welding position at which the first end is welded to the second end is compressed to form an explosion-proof recess.

2. The battery case according to claim 1, wherein a weld seam is formed at the welding position of the first end and the second end, a length of the explosion-proof recess extends in a length direction of the weld seam.

3. The battery case according to claim 2, wherein the length of the explosion-proof recess is equal to the length of the weld seam.

4. The battery case according to claim 1, wherein a width of the explosion-proof recess is in a range of 0.3 mm to 2 mm.

5. The battery case according to claim 1, wherein the explosion-proof recess extends to reach at least one of the first end and the second end.

6. The battery case according to claim 2, wherein the explosion-proof recess extends to reach at least one of the first end and the second end.

7. The battery case according to claim 1, wherein each of an outer side wall and an inner side wall of the case body defines the explosion-proof recess, the explosion-proof recess in the outer side wall is directly facing towards the explosion-proof recess in the inner side wall.

8. The battery case according to claim 2, wherein each of an outer side wall and an inner side wall of the case body defines the explosion-proof recess, the explosion-proof recess in the outer side wall is directly facing towards the explosion-proof recess in the inner side wall.

9. The battery case according to claim 1, wherein a thickness d of a side wall of the case body is greater than a depth h of the explosion-proof recess, and 0.15≤d≤0.7 mm, 0.05≤h≤0.2 mm.

10. The battery case according to claim 2, wherein a thickness d of a side wall of the case body is greater than a depth h of the explosion-proof recess, and 0.15≤d≤0.7 mm, 0.05≤h≤0.2 mm.

11. The battery case according to claim 1, wherein the explosion-proof recess has a recess bottom and two recess side walls, the two recess side walls are opposite to each other, the recess bottom is disposed between the two recess side walls, an angle between the recess bottom and each of the two recess side walls is in a range of 100° to 160°.

12. The battery case according to claim 2, wherein a length of the case body is in a range of 100 mm to 2500 mm.

13. The battery case according to claim 7, wherein an opening of the explosion-proof recess defined in the outer side wall and an opening of the explosion-proof recess defined in the inner side wall face opposite to each other; and an orthographic projection of a bottom of the explosion-proof recess defined in the outer side wall the explosion-proof recess defined in the inner side wall directly locates on a bottom of the explosion-proof recess defined in the inner side wall.

14. A battery, comprising a battery and a battery case, wherein,
the battery case comprises a case body, the case body is a one-piece and integral structure defining a receiving space, the battery is received in the receiving space;
a wall of the case body defines an explosion-proof recess configured to release a high pressure generated inside the case body.

15. The battery according to claim 14, wherein a width of the explosion-proof recess is in a range of 0.3 mm to 2 mm.

16. The battery according to claim 14, wherein each of an outer side wall and an inner side wall of the case body defines the explosion-proof recess, the explosion-proof recess in the outer side wall is directly facing towards the explosion-proof recess in the inner side wall.

17. The battery according to claim 15, wherein an opening of the explosion-proof recess defined in the outer side wall and an opening of the explosion-proof recess defined in the inner side wall face opposite to each other; and an orthographic projection of a bottom of the explosion-proof recess defined in the outer side wall the explosion-proof recess defined in the inner side wall directly locates on a bottom of the explosion-proof recess defined in the inner side wall.

18. The battery according to claim 14, wherein a thickness of a side wall of the case body is greater than a depth of the explosion-proof recess, and 0.15≤d≤0.7 mm, 0.05≤h≤0.2 mm.

19. The battery according to claim 14 wherein the explosion-proof recess has a recess bottom and two recess side walls, the two recess side walls are opposite to each other, the recess bottom is disposed between the two recess side walls, an angle between the recess bottom and each of the two recess side walls is in a range of 100° to 160°.

20. The battery according to claim 14, wherein a length of the case body is in a range of 100 mm to 2500 mm.
